(19) United States
(12) Patent Application Publication
(10) Pub. No.: US 2009/0206496 A1
(43) Pub. Date: Aug. 20, 2009

(54) WATER-COOLING FAN WITH HUMIDIFYING EFFECT

(76) Inventor: Ming-Tsung Lee, Tainan City (TW)

Correspondence Address: Ming-Tsung LEE, P. O. BOX 90, Tainan City, 70499, TW

(21) Appl. No.: 12/030,875

(22) Filed: Feb. 14, 2008

(51) Int. Cl. F24F 5/00; B01F 3/04

(52) U.S. Cl. 261/28; 261/107

(57) ABSTRACT

A water-cooling fan with humidifying effect includes a main body, a cloth curtain and a filter. The main body has a fan, an air outlet formed at its front, an air inlet formed at its rear, a plugging groove positioned respectively at two sides of the air inlet, a water tank, a pump and a sink. The circumference of the air inlet is attached with a Velcro band corresponding to a Velcro band fixed around the circumference of the cloth curtain. The water tank has an opening for the cloth curtain to extend into it, a water-exiting tube connected with the pump, and at least one heater fixed in its bottom. The sink has a plurality of water-dropping holes in its bottom and a water-entering tube for being connected with the pump. Such a fan can be used as a water-cooling fan or used to increase indoor humidity if necessary.

### BACKGROUND OF THE INVENTION

1. Field of the Invention

This invention relates to a water-cooling fan with humidifying effect, particularly to one able to cool down circulation air, make air circulated with an increased humidity if necessary, and have its cloth curtain and filter quickly disassembled for cleaning.

2. Description of the Prior Art

Commonly, in order to cool down hot indoor air with heat in summer or in a chamber, fans are used to quickly enhance air circulation to make people feel a little better, or air conditioners are employed to directly cool down temperature. Although conventional fans can speed air circulation but temperature is not lowered. As for air conditioners with any capacity, although they can satisfactorily drop down temperature but they have a rather high hardware cost and consume too much energy in comparison with conventional fans. Moreover, the heat exhausted is one of the factors making climate warming up.

And, during the autumn and winter season with cold dry air, a humidifier is always operated additionally to raise indoor humidity. It not only poses an additional expense but also needs some space for storing while not using.

### SUMMARY OF THE INVENTION

The main objective of this invention is to offer a water-cooling fan to provide cooled circulation air and able to make air circulated with an increased humidity if necessary.

A second object of this invention is to offer a water-cooling fan to enable its cloth curtain and its filter easily disassembled for conveniently cleaning them.

The main characteristic of the invention is to provide a water-cooling fan including a main body, a cloth curtain and a filter. The main body is provided with a fan installed therein, an air outlet formed at a front side thereof, an air inlet formed at a rear side thereof, a water tank installed therein, a pump installed therein, and a sink fixed at an upper portion thereof. The water tank is provided with an opening bored at one side thereof, a water-exiting tube located at a lower portion thereof for connecting with the pump, and at least one heater fixed therein. The sink is provided with a plurality of water-dropping holes bored in a bottom thereof and a water-entering tube for connecting with the pump via a water tube. The cloth curtain is fitted in the air inlet of the main body. The filter is assembled outside the air inlet of the main body.

### BRIEF DESCRIPTION OF DRAWINGS

This invention is better understood by referring to the accompanying drawings, wherein:

FIG. 1 is an exploded perspective view of a preferred embodiment of a water-cooling fan with humidifying effect in the present invention;

FIG. 2 is a perspective view of the preferred embodiment of a water-cooling fan with humidifying effect in the present invention;

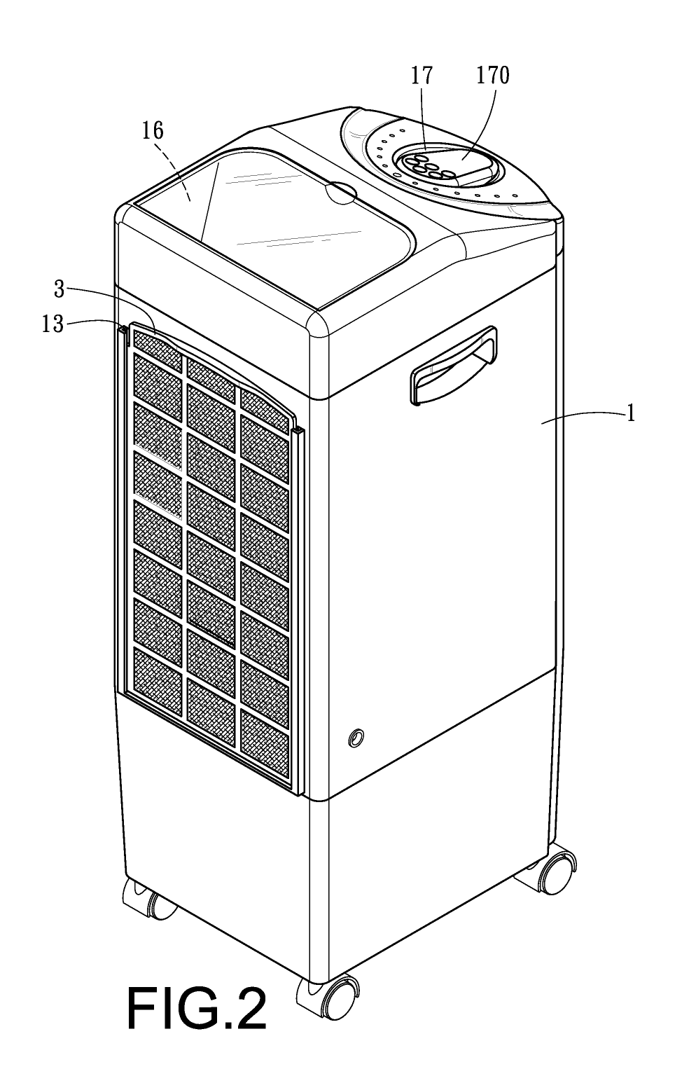

FIG. 3 is a partial side cross-sectional view of the preferred embodiment of a water-cooling fan with humidifying effect in the present invention;

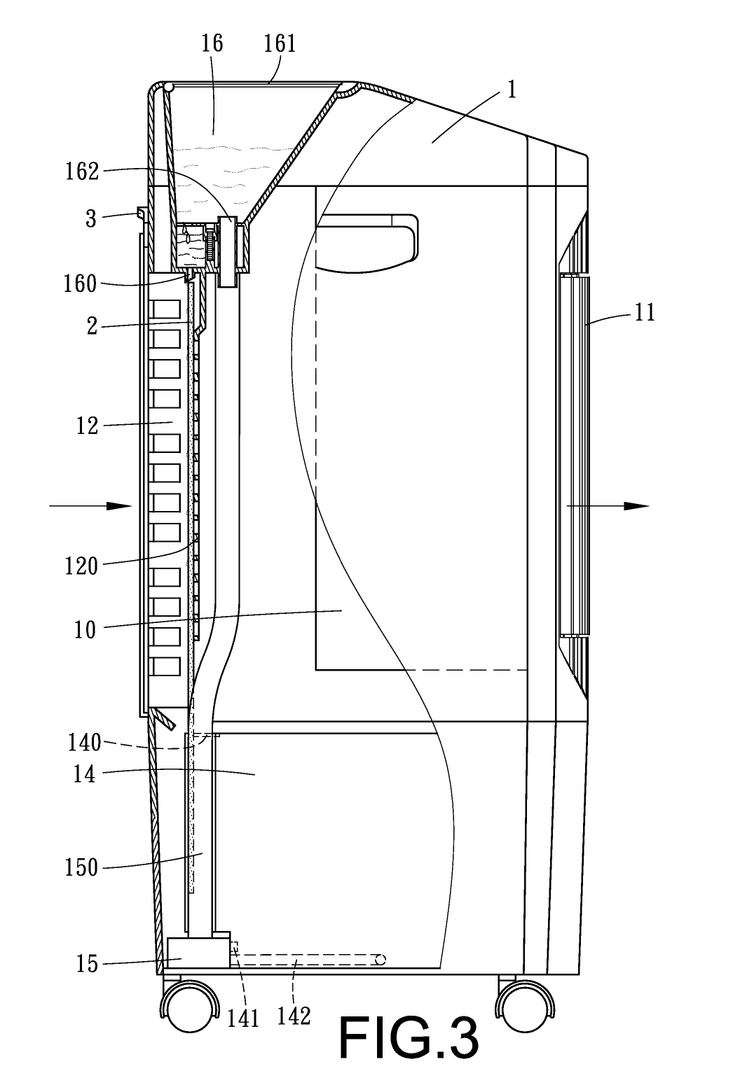

FIG. 4 is a perspective view of the preferred embodiment of a water-cooling fan with humidifying effect in the present invention, showing it being operated to make circulation air humidified; and

FIG. 5 is a side cross-sectional view of the preferred embodiment of a water-cooling fan with humidifying effect in the present invention, showing it being operated to make circulation air humidified.

### DETAILED DESCRIPTION OF THE PREFERRED EMBODIMENT

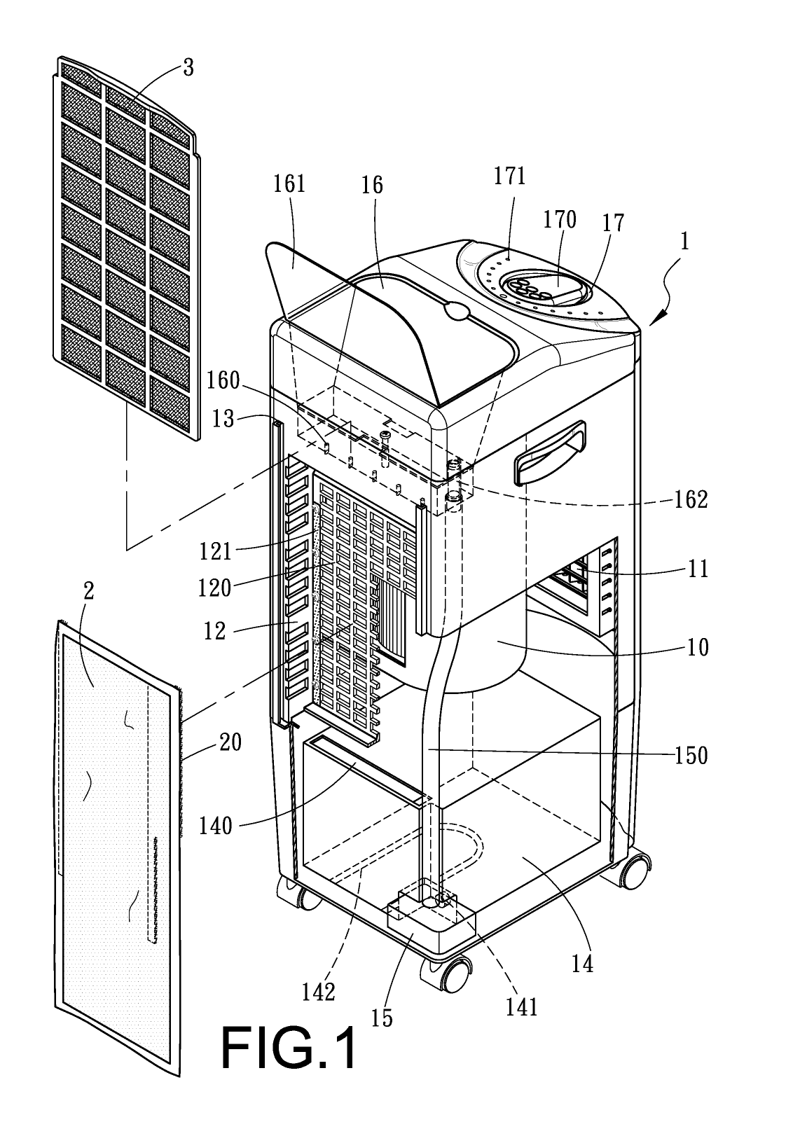

As shown in FIGS. 1˜3, a preferred embodiment of a water-cooling fan with humidifying effect in the present invention consists of a main body 1, a cloth curtain 2 and a filter 3.

The main body 1 is provided with a fan 10 installed therein, an air outlet 11 formed at a front side thereof, an air inlet 12 formed at a rear side thereof, a plugging groove 13 respectively positioned at two sides of the air inlet 12, a water tank 14 installed therein, a pump 15 installed therein, a sink 16 fixed at an upper portion thereof and a groove 17 fixed at a top thereof. The air inlet 12 is provided with a grating 120 disposed therein, and a Velcro band 121 attached around a circumference thereof. The water tank 14 made of materials resistant to high temperature is provided with a rectangular opening 140 bored at one side thereof, a water-exiting tube 141 located at a lower portion thereof for connecting with the pump 15, and at least one heater 142 fixed therein. The sink 16 is provided with a plurality of water-dropping holes 160 bored in a bottom thereof, a pivotal cover 161 pivotally fixed on a top thereof, and a water-entering tube 162 for connecting with the pump 15 via a water tube 150. The groove 17 capable of depositing a remote controller 170 is provided with a plurality of indicating lights 171 positioned around a circumference thereof.

The cloth curtain 2 fitted in the air inlet 12 of the main body 1 is provided with a Velcro band 20 attached around a circumference thereof for being adhered with the Velcro band 121 of the air inlet 12 and has a bottom inserted through the opening 140 to extend into the water tank 14.

The filter 3 assembled outside the air inlet 12 of the main body 1 has both sides fitted in the two plugging grooves 13 of the main body 1.

In using the invention as a water-cooling fan, as shown in FIGS. 1˜3, firstly attach the Velcro band 20 of the cloth curtain 2 with the Velcro band 121 of the air entrance 12. Secondly, fit both sides of the filter 3 in the two plugging grooves 13 of the main body 1. Thirdly, add water into the sink 16, and then the water is discharged from the plurality of water-dropping holes 160 to flow down through the cloth curtain 2 to enter the water tank 14. Finally, turn on the remote controller 170 to actuate the pump 15 and the fan 10, by which the water in the water tank 14 is to be pumped up by the pump 15 into the sink 16 to keep the water continuously flowing through the plurality of water-dropping holes 160 to wet the cloth curtain 2 and air is to be sucked in by the fan 10 through the air inlet 12 to pass through the damp cloth curtain 2 for being cooled down to flow out of the air outlet 11.

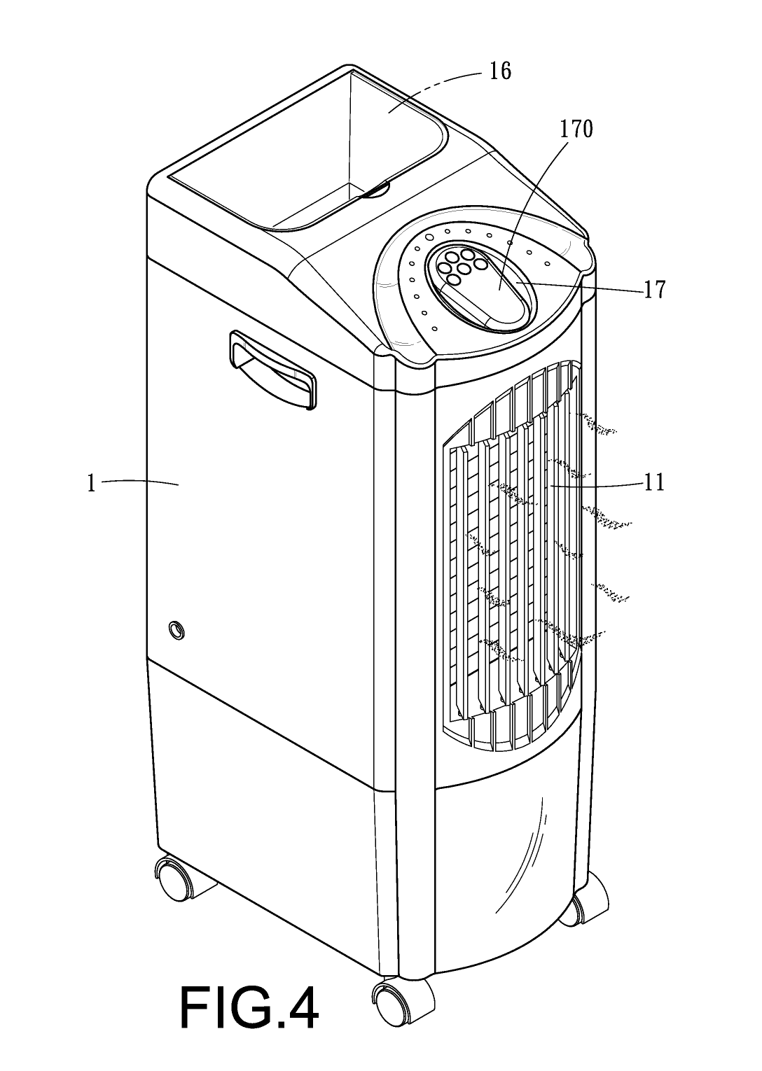

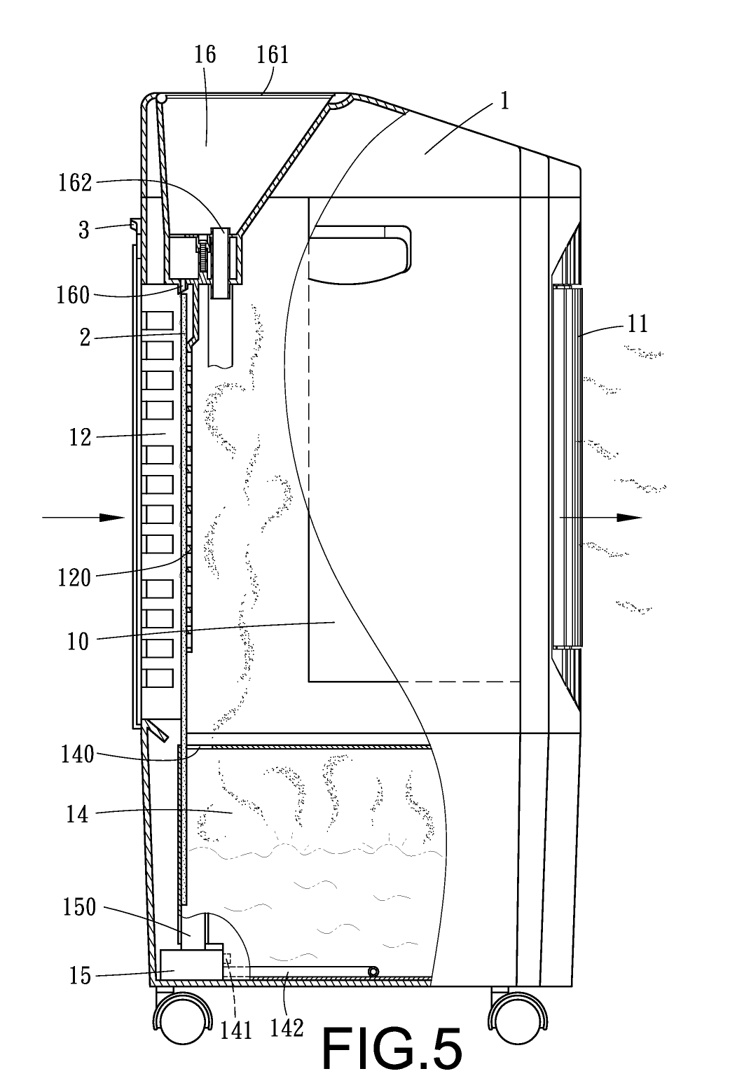

When the weather becomes dry and cold, the at least one heater 142 of the water tank 14 can be turned on to heat the water in the water tank 14 to create warm vapor coming upwards, and then air is to be sucked in by the fan 10 through the air inlet 12 to blow the warm vapor to flow out of the air outlet 11, thus increasing the indoor humidity and temperature, as shown in FIGS. 4 and 5.

Therefore, the invention has double functions: first, it can be used as a water-cooling fan to quickly provide cooled air; second, it can increase humidity and supply warmer circulation if necessary.

While the preferred embodiment of the invention has been described above, it will be recognized and understood that various modifications may be made therein and the appended claims are intended to cover all such modifications that may fall within the spirit and scope of the invention.

What is claimed is:

1. A water-cooling fan with humidifying effect, said water-cooling fan comprising:
a main body provided with a fan installed therein, an air outlet formed at a front side thereof, an air inlet formed at a rear side thereof, a water tank installed therein, a pump installed therein, and a sink fixed at an upper portion thereof, said water tank provided with an opening bored at one side thereof, a water-exiting tube located at a lower portion thereof for connecting with said pump, and at least one heater fixed therein, said sink provided with a plurality of water-dropping holes bored in a bottom thereof and a water-entering tube for connecting with said pump via a water tube;
a cloth curtain fitted in said air inlet of said main body; and,
a filter assembled outside said air inlet of said main body.

2. The water-cooling fan with humidifying effect as claimed in claim 1, wherein said air inlet of said main body is provided with a grating disposed therein and a Velcro band attached around a circumference thereof; and a plugging groove is respectively positioned at two sides of said air inlet.

3. The water-cooling fan with humidifying effect as claimed in claim 1, wherein said sink of said main body is provided with a pivotal cover pivotally fixed on a top thereof.

4. The water-cooling fan with humidifying effect as claimed in claim 1, wherein said main body is provided with a groove fixed at a top thereof for depositing a remote controller.

5. The water-cooling fan with humidifying effect as claimed in claim 1, wherein said cloth curtain is provided with a Velcro band attached around a circumference thereof and has a bottom inserted through said opening to extend into said water tank.
